(19) United States
(12) Patent Application Publication
(10) Pub. No.: US 2026/0084401 A1
(43) Pub. Date: Mar. 26, 2026

(54) ARC FLASH PROTECTIVE MATERIALS

(71) Applicants: W. L. Gore & Associates, Inc., Newark, DE (US); W. L. Gore & Associates GmbH, Putzbrunn (DE)

(72) Inventors: James Ellis, Newark, DE (US); Miguel Calixto, Putzbrunn (DE)

(21) Appl. No.: 19/109,748

(22) PCT Filed: Sep. 8, 2023
(86) PCT No.: PCT/US2023/073714

§ 371 Date: Mar. 7, 2025

Related U.S. Application Data
(60) Provisional application No. 63/405,156, filed on Sep. 9, 2022.

(51) Int. Cl. B32B 7/027; B32B 5/02; B32B 7/09; B32B 27/12; B32B 27/20

(52) U.S. Cl. CPC B32B 7/027; B32B 5/02; B32B 7/09; B32B 27/12; B32B 27/20; B32B 2307/3065; B32B 2307/718; B32B 2437/00

(57) ABSTRACT

This disclosure relates to relatively thin and light weight multilayer textile composites that can provide a high level of protection from the thermal hazards associated with an electrical are flash. The multilayer textile composites comprise a laminate layer stitched with one or more of a laminate or flame retardant textile layer(s).

### FIELD OF THE INVENTION

The present invention relates to protective multilayer textile composites. More particularly, the present invention relates to lightweight textile composites that provide protection against high energy electric arc flashes and similar types of applied energy.

### BACKGROUND

In order to reduce injuries, protective clothing is desired for professionals working in hazardous environments where short duration exposure to electric arc flashes is possible, such as utility repair. Protective gear for workers exposed to these conditions should provide protection to allow the wearer to get away from the hazard quickly and safely, rather than to repair the hazard. The National Fire Protection Association (NFPA) recognizes several levels of electrical arc flash discharge. In order for protective clothing to be rated to provide a level of protection to the wearer, there are minimum protection standards that the clothing must exhibit in order to be sold as protective garments. For example, garments rated as Category 1 level of personal protective equipment (PPE) must be able to protect the wearer from an electric discharge of 4 calories per square centimeter (cal/cm²). Category 2 PPE must be able to protect from 8 cal/cm², Category 3 PPE must protect from 25 cal/cm², Category 4 PPE must protect from 40 cal/cm², and Category 5 PPE must protect from a minimum of 75 cal/cm² electric arc discharge. In general, as the NFPA Category ratings progress from class 1 to class 5, the weight and bulk of the PPE increases significantly.

Traditionally, arc-resistant protective garments provide fire and heat protection. Such garments have been made with an outermost layer of an ensemble comprising non-combustible, non-melting fabric made of, for example, aramids, polybenzimidazole (PBI), poly p-phenylene-2,6-benzobisoxazole (PBO), modacrylic blends, polyamines, carbon, polyacrylonitrile (PAN), and blends and combinations thereof. These fibers may be inherently flame resistant but may have several limitations. Specifically, in order to achieve the desired level of protection, relatively heavy weight, relatively thick and bulky textiles or multiple layers of these textiles are required. Typically, these fabrics can have a basis weight in excess of 400 grams/meter². As an example, a commercially available Class 5 garment can have at least 3 layers, a thickness of about 4 millimeters, and an overall weight of over 800 grams per square meter. The fibers used to form these fabrics may also be very expensive, difficult to dye and print, and may not have adequate abrasion resistance. Additionally, these fibers pick up more water and offer unsatisfactory tactile comfort as compared to nylon or polyester based fabrics. For optimum user performance in environments with occasional arc flash exposure, a lightweight, breathable, water resistant garment with enhanced burn protection is desired. The cost of waterproof, arc flash resistant, protective clothing has been an important consideration for the large number of hazardous exposure applications, thereby precluding the use of typical, inherently flame-resistant textiles such as those used in firefighting community.

### SUMMARY

This disclosure provides relatively thin and light weight multilayer textile composites that are able to provide a high level of protection from the thermal hazards of an electrical arc flash, for example, the multilayer textile composites can provide protection from an electric arc discharge ranging from 40 cal/cm² to over 100 cal/cm². In a first aspect, there is provided a multilayer textile composite comprising: A) a first portion; and B) a second portion, wherein the first portion comprises a first laminate comprising; a1) a first meltable layer; a2) a first layer of a heat reactive material comprising a polymer resin and expandable graphite; and a3) a first barrier layer; wherein the first portion and the second portion are attached to each other via one or more stitches. In a second aspect, the first laminate further comprises a4) a first flame retardant (FR) textile, wherein the first flame retardant textile layer is adjacent to the first barrier layer, opposite the first layer of heat reactive material.

In a third aspect, the multilayer textile composite of the first or second aspect comprises a second portion, wherein the second portion comprises b) a second laminate, the second laminate comprising b1) a second meltable layer; b2) a second layer of heat reactive material comprising a polymer resin and expandable graphite; and b3) a second barrier layer.

In a fourth aspect, the multilayer textile composite of any of the previous aspects, the second laminate further comprises b4) a second flame retardant textile and the second flame retardant textile is adjacent to the second barrier layer opposite the second layer of heat reactive material.

In a fifth aspect, the multilayer textile composite of the first or second aspect comprises a second portion, wherein the second portion comprises a third flame retardant textile.

In a sixth aspect, the second portion is adjacent to the first barrier layer of the first portion.

In a seventh aspect, the second portion is adjacent to the first flame retardant textile of the first portion.

In an eighth aspect, the second portion comprises the second laminate, and the second meltable layer is adjacent to the first barrier layer of the first portion.

In a ninth aspect, the second portion comprises the second laminate, and the second meltable layer is adjacent to the first flame retardant textile of the first portion.

In a tenth aspect, the multilayer textile composite of any of the previous aspects comprises a third portion, wherein the third portion is a fourth flame retardant textile, and the third portion is positioned between the first portion and the second portion.

In an eleventh aspect, the multilayer textile composite of any of the previous aspects comprises one or more stitches, wherein the stitches are quilting stitches, a series of one or more stitch lines, a series of overlapping stitch lines, a series of stitched geometric shapes, a series of stitches in a grid pattern, a series of stitches that are essentially parallel to each other, a series of tack stitches, or a combination thereof.

In a twelfth aspect, the multilayer composite textile of any of the previous aspects comprises quilted stitches, wherein the quilted stitches are in a stitch pattern comprising one or more land areas, wherein each land area is bordered by the quilting stitches, and wherein the land areas of the quilted pattern are in a range of from 1 centimeter² (cm²) to 450 cm².

In a thirteenth aspect, the first meltable textile, the second meltable textile and the flame retardant textiles of any one of the previous aspects each are independently a knit, a woven, a nonwoven textile or a combination thereof.

In a fourteenth aspect, the first meltable textile and the second meltable textile of any of the previous aspects can independently comprise polyamide fibers, polyester fibers, polyolefin fibers, acrylic fibers, polyurethane fibers, or a combination thereof.

In a fifteenth aspect, the flame retardant textile of any of the previous aspects can comprise aramid, p-aramid, m-aramid, polybenzimidazole, polybenzoxazole, polyetheretherketone, polyetherketoneketone, polyphenylene sulfide, polyimide, polyamide imide, melamine, fluoropolymer, polytetrafluoroethylene, modacrylic, cellulose, FR cellulose, FR viscose, polyvinylacetate, mineral fibers, protein fibers, or a combination thereof.

In a sixteenth aspect, the first layer of heat reactive material and the second layer of heat reactive materials of any of the previous aspects can be independently applied in a continuous or a discontinuous manner.

In a seventeenth aspect, the multilayer textile composite of any one of the previous aspects has a weight in the range of from 250 to 800 grams per square meter (gsm).

In an eighteenth aspect, the first and/or the second barrier layer of any of the previous aspects can independently comprise expanded polytetrafluoroethylene (ePTFE), polytetrafluoroethylene, polyurethane, polyethylene (PE) or a combination thereof.

In a nineteenth aspect, one or both of the first and second barrier layers of any of the previous aspects independently comprise a multilayer film comprising two or more layers of ePTFE and polyurethane.

In a twentieth aspect, the multilayer textile composite of any previous aspect, wherein the stitches connect at least a portion of the thickness of the first portion with at least a portion of the thickness of the second portion.

In a twenty-first aspect, the multilayer textile composite of any previous aspect, wherein the stitches connect the entire thickness of the first portion with the entire thickness of the second portion.

In a twenty-second aspect, the multilayer textile composite of any of the previous aspects, wherein the stitches are present on at least one surface of the multilayer textile composite or wherein the stitches are present on both surfaces of the multilayer textile composite.

In a twenty-third aspect, the disclosure relates to an article comprising the multilayer textile composite of any of the previous aspects.

In a twenty-fourth aspect, the article of the previous aspect is a blanket, a garment, a jacket, a coat, a vest, a pair of pants, overalls, coverall, leggings, a shirt, gloves, footwear, headwear, a hood, a hat, or a combination thereof.

In a twenty-fifth aspect, the disclosure relates to the garment of the twenty-fourth aspect, wherein the article is a garment, and the first portion of the multilayer textile composite is positioned on an exterior side of the garment.

In a twenty-sixth aspect, the article of any one of the previous aspects provides an Arc Thermal Performance Value of at least 40 calories/centimeter² (cal/cm²), when tested according to ASTM F1959.

### Multilayer Textile Composite

The present disclosure relates to a multilayer textile composite comprising A) a first portion; and B) a second portion, wherein the first portion and the second portion are attached to each other via one or more stitches. The first portion comprises a) a first laminate, the first laminate comprising a1) a first meltable layer; a2) a first layer of a heat reactive material comprising a polymer resin and expandable graphite; and a3) a first barrier layer. It is believed that the first portion is capable of dissipating a first portion of energy of an arc flash exposure thereby minimizing the amount of energy that is transmitted to the second portion. Optionally, the multilayer textile composite further comprises a third portion, wherein the third portion is located between the first and second portion and is attached to the multilayer composite textile via the one or more stitches.

The first portion comprises a first laminate, the first laminate comprising a1) a first meltable layer, a2) a first layer of a heat reactive material comprising a polymer resin and expandable graphite, and a3) a barrier layer. The first portion may further comprise a4) a first flame retardant textile, wherein the first flame retardant textile is adjacent to the first barrier layer. In some embodiments, the first meltable layer is a textile that is the outermost layer of one side of the multilayer textile composite. The first meltable layer can be a woven, a knit, or a nonwoven textile layer. The first meltable layer may be a meltable textile. As used herein, the term “meltable” is a material that is meltable according to the Melting and Thermal Stability test described hereinafter.

In some embodiments, the second portion can be a second laminate comprising b1) a second meltable layer, b2) a second layer of heat reactive material comprising a polymer resin and expandable graphite, and b3) a second barrier layer. In some embodiments, the second laminate can further comprise b4) a second flame retardant textile.

In other embodiments, the second portion can be a third flame retardant textile. The third flame retardant textile can be adjacent to the first barrier layer or to the first flame retardant textile, if one is present. The first portion is attached to the second portion via one or more stitches.

The multilayer textile composite can have a weight in the range of from 250 to 800 grams per square meter (gsm). In other embodiments, the multilayer textile composite can have a weight in the range of from 250 to 750 gsm, or from 250 to 700 gsm, or from 250 to 675 gsm, or from 250 to 650 gsm, or from 250 to 625 gsm, or from 250 to 600 gsm, or from 275 to 800 gsm, or from 275 to 750 gsm, or from 275 to 700 gsm, or from 275 to 675 gsm, or from 275 to 650 gsm, or from 275 to 625 gsm, or from 375 to 600 gsm.

In further embodiments, the multilayer textile composite may be relatively thin, for example, having a thickness in a range of from 1.25 millimeters (mm) to 3.0 mm. In other embodiments, the multilayer textile composite may have a thickness in the range of from 1.3 mm to 2.9 mm or from 1.4 mm to 2.8 mm or from 1.4 mm to 2.75 mm or from 1.4 mmm to 2.7 mm or from 1.4 mm to 2.6 mm.

The length and width of the multilayer textile composite is much greater than the thickness. For example, the multilayer textile composite can be from 10 centimeters wide to about several meters wide. The length of the multilayer textile composite can be from 10 centimeters to many hundreds or thousands of meters long. In this way, the multilayer textile composite has a first major side and a second major side opposite the first side. The first side, i.e., the first major side, can be the first portion, specifically, the first meltable layer forms the first side of the multilayer textile composite. The second side, i.e., the second major side of the multilayer textile composite depends upon the second portion. In some embodiments, the second side can be the second barrier layer, the second flame retardant textile, or the third flame retardant textile.

### Meltable Layer

The multilayer textile composite comprises a first meltable layer, and optionally, a second meltable layer. The following description of a meltable layer, while provided in terms for the first meltable layer, is applicable to both the first meltable layer and the second meltable layer, unless otherwise noted. The first meltable layer comprises a textile layer, wherein the textile is a knit, a woven, a nonwoven, or a combination thereof. The first meltable layer can comprise one or more meltable fibers, for example, polyamide fibers, polyester fibers, polyolefin fibers, acrylic fibers, polyurethane fibers, or a combination thereof. The meltability of a meltable textile layer can be determined using the Melting and Thermal Stability test provided herein.

The first meltable layer may comprise relatively small quantities of flame retardant fibers, non-meltable fibers and/or antistatic fibers. If present, the flame retardant fibers, the non-meltable fibers and/or the antistatic fibers are present so that the first meltable textile is still a meltable textile when tested according to the Melting and Thermal Stability test described hereinafter. In some embodiments, the first meltable layer may be a meltable non-flammable textile such as, for example, a phosphinate modified polyester (such as materials sold under the trade name TREVIRA® CS by Trevira GmbH of Hattersheim Germany and under the trade name AVORA® FR by Rose Brand of Secaucus, New Jersey, USA).

The first meltable layer may comprise a quantity of meltable fibers in a range from 50% to 100% by weight of meltable fibers. The first meltable layer may comprise a quantity of meltable fibers in a range from 75 to 100% by weight. The first meltable layer may comprise a quantity of meltable fibers in a range from 90% to 100% by weight. The first meltable layer may comprise a quantity of meltable fibers in a range from 95% to 99% by weight. The remainder of the fibers may be antistatic fibers, meltable elastic fibers, non-meltable elastic fibers or a combination thereof. For example, when the first meltable layer comprises a quantity of meltable fibers in a range from 95 to 99% by weight, the antistatic and/or elastic fibers may be present in the range of from 1 to 5% by weight. All percentages by weight are based on the total weight of the first meltable layer.

The first meltable layer may have a weight of less than or equal to about 250 gsm. In other embodiments, the first meltable layer may have a weight of from 30 gsm to 250 gsm, or a weight of from 40 gsm to 200 gsm, or a weight of from 40 gsm to 175 gsm, or a weight of from 50 gsm to 200 gsm, or a weight of about 60 gsm to 200 gsm, or a weight of from 50 gsm to 180 gsm, or a weight of about 60 gsm to 180 gsm, or a weight of from 50 gsm to 175 gsm, or a weight of about 60 gsm to 175 gsm, or a weight of from 75 gsm to 200 gsm, or a weight of about 75 gsm to 180 gsm.

The first meltable layer may be a flammable or non-flammable material. As used herein, a “flammable” material is a material that is flammable when tested according to the Vertical Flame Test for Textiles described hereinafter to determine whether it is flammable or non-flammable.

The first meltable layer may comprise polyester fibers, polyamide fibers, polyolefin fibers, acrylic fibers, polyurethane fibers, or a combination thereof. Suitable polyesters can include, for example, polyethylene terephthalate, polytrimethylene terephthalate, polybutylene terephthalate or a combination thereof. Suitable polyamides, can include, for example, nylon 6, nylon, 6,6 or a combination thereof. Suitable polyolefins can include, for example, polyethylene, polypropylene or a combination thereof. In some embodiments, the first meltable layer comprises polyamide fibers, polyester fibers, polyolefin fibers, or a combination thereof.

Meltable textiles are not typically used in arc resistant laminates as the standards governing the requirements for arc resistant garments requires that the fabric or laminate be flame resistant in order to even qualify for arc testing (ASTM 1959). It is surprising that a multilayer textile composite comprising an outer textile layer that is meltable can be used to provide protection against arc flash incidents.

### Heat Reactive Material

The first portion of the multilayer textile composite also comprises a first layer of heat reactive material comprising a polymer resin and expandable graphite. The first layer of the heat reactive material may be positioned between the first meltable layer and the first barrier layer. This first layer of the heat reactive layer can act as an adhesive to attach or bond the first meltable layer to the first barrier layer. A second layer of the heat reactive material can be positioned between the second meltable layer and the second barrier layer of the second portion. The second layer of heat reactive material can also act as an adhesive to attach or bond the second meltable layer to the second barrier layer. The following description of the heat reactive material is applicable to both the first and second layers of the heat reactive material, unless otherwise noted.

The layer of heat reactive material can act as an adhesive, securing the first meltable layer to the first barrier layer or securing the second meltable layer to the second barrier layer. In some embodiments, the layers of heat reactive material may be applied as a continuous layer. In other embodiments, the heat reactive material may be applied as a discontinuous layer. The heat reactive material may be applied discontinuously to form a layer of heat reactive material having less than 100% surface coverage. The heat reactive material may be applied in a pattern of discontinuous forms. The heat reactive material may be applied in a dot pattern, grid pattern, line pattern, wave pattern, or any other pattern, or combinations thereof.

The heat reactive material may comprise expandable graphite. The heat reactive material may comprise a polymer resin. The heat reactive material may comprise a mixture of expandable graphite and a polymer resin.

The expandable graphite may expand by at least about 400 microns in the TMA Expansion Test described herein when heated to about 240° C. The expandable graphite may expand by at least about 500 microns in the TMA Expansion Test described herein when heated to about 240° C. The expandable graphite may expand by at least about 600 microns in the TMA Expansion Test described herein when heated to about 240° C. The expandable graphite may expand by at least about 700 microns in the TMA Expansion Test described herein when heated to about 240° C. The expandable graphite may expand by at least about 800 microns in the TMA Expansion Test described herein when heated to about 240° C. The expandable graphite may expand by at least about 900 microns in the TMA Expansion Test described herein when heated to about 280° C.

The expandable graphite may have an average expansion of at least about 4 cubic centimeters per gram (cc/g), or at least about 5 cubic centimeters per gram (cc/g), or at least about 6 cubic centimeters per gram (cc/g), or at least about 7 cubic centimeters per gram (cc/g), or at least about 8 cubic centimeters per gram (cc/g), or at least about 9 cubic centimeters per gram (cc/g), or at least about 10 cubic centimeters per gram (cc/g), or at least about 11 cubic centimeters per gram (cc/g), or at least about 12 cubic centimeters per gram (cc/g), or at least about 19 cubic centimeters per gram (cc/g), or at least about 20 cubic centimeters per gram (cc/g), or at least about 21 cubic centimeters per gram (cc/g), or at least about 22 cubic centimeters per gram (cc/g), or at least about 23 cubic centimeters per gram (cc/g) or at least about 24 cubic centimeters per gram (cc/g), or at least about 25 cubic centimeters per gram (cc/g) at 300° C. when tested using the Furnace Expansion Test described herein. For example, the expandable graphite may have an average expansion of about 19 cc/g at 300° C. when tested using the Furnace Expansion Test described herein.

The expandable graphite may have an endotherm greater than or equal to about 50 J/g, or greater than or equal to about 75 J/g, or greater than or equal to about 100 J/g, or greater than or equal to about 125 J/g, or greater than or equal to about 150 J/g, or greater than or equal to about 175 J/g, or greater than or equal to about 200 J/g, or greater than or equal to about 225 J/g, or greater than or equal to about 250 J/g. Differential Scanning calorimetry (DSC) can be used to determine the endothermic values of the expandable graphite materials.

The heat reactive material may comprise expandable graphite with an average expansion of at least about 4 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 100 Joules per gram (J/g) when tested according to the DSC Endotherm Test method described herein. The heat reactive material may comprise expandable graphite with an average expansion of at least about 8 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 100 Joules per gram (J/g) when tested according to the DSC Endotherm Test

Heat reactive materials may comprise expandable graphite with an average expansion of at least about 4 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 8 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 150 Joules per gram (J/g) when tested according to the DSC Endotherm Test

Heat reactive materials may comprise expandable graphite with an average expansion of at least about 4 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 8 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 200 Joules per gram (J/g) when tested according to the DSC Endotherm Test

Heat reactive materials may comprise expandable graphite with an average expansion of at least about 4 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 8 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 250 Joules per gram (J/g) when tested according to the DSC Endotherm Test

The size of the expandable graphite particles may be chosen so that the heat reactive material may be applied with a selected application method. For example, if the heat reactive material is applied by a gravure printing technique, the expandable graphite particle size should be small enough to fit in the gravure cells.

The heat reactive material may comprise a polymer resin. The polymer resin may have a melt or softening temperature of less than about 280° C. The polymer resin may be sufficiently flowable or deformable to allow the expandable graphite to expand substantially upon heat exposure at or below about 300° C. The polymer resin may be sufficiently flowable or deformable to allow the expandable graphite to expand substantially upon heat exposure at or below about 280° C. The polymer resin may allow the expandable graphite to sufficiently expand at temperatures below the pyrolysis temperature of the first and/or second meltable layers. The extensional viscosity of the polymer resin may be low enough to allow for the expansion of expandable graphite and high enough to maintain the structural integrity of the heat reactive material after expansion of the mixture of polymer resin and expandable graphite. These factors can be quantified by the storage modulus and tan delta of the polymer.

The polymer resin may have a storage modulus of at least about 103 dyne/cm2. The polymer resin may have a storage modulus from 103 to 108 dyne/cm2. The polymer resin may have a storage modulus from 103 to 107 dyne/cm2. The polymer resin may have a storage modulus from 103 to 106 dyne/cm2. The polymer resin may have a storage modulus from 103 to 105 dyne/cm2. The polymer resin may have a storage modulus from 103 to 104 dyne/cm2. Storage modulus is a measure of a polymer elastic behavior and can be measured using Dynamic Mechanical Analysis (DMA). The polymer resin may have a Tan delta from about 0.1 to about 10 at 200° C. Tan delta is the ratio of the loss modulus to the storage modulus and can also be measured using DMA techniques.

The polymer resins may have a modulus and elongation at around about 300° C., or less, suitable to allow the expandable graphite to expand. The polymer resins may be elastomeric. The polymer resins may be cross-linkable, such as crosslinkable polyurethane. The polymer resins may be thermoplastic.

The polymer resin may comprise polymers which include but are not limited to polyesters, polyether, polyurethane, polyamide, acrylic, vinyl polymer, polyolefin, silicone, epoxy or a combination thereof.

The heat reactive material and/or the polymer resin may comprise a flame retardant material. The flame retardant material may comprise melamine, phosphorous, metal hydroxides such as alumina trihydrate (ATH), borates, or a combination thereof. The flame retardant material may comprise brominated compounds, chlorinated compounds, antimony oxide, organic phosphorous-based compounds, zinc borate, ammonium polyphosphate, melamine cyanurate, melamine polyphosphate, molybdenum compounds, magnesium hydroxide, triphenyl phosphate, resorcinol bis-(diphenylphosphate), bisphenol-A-(diphenylphosphate), tricresyl phosphate, organophosphinates, phosphonate esters or a combination thereof. If present, the flame retardant materials may be used in a proportion of from 1% to 50% by weight, based on the total weight of the polymer resin.

The heat reactive material may form a plurality of tendrils comprising expanded graphite upon exposure to the heat from an electrical arc. The total surface area of the heat reactive material may increase significantly when compared to the same mixture prior to expansion. For example, the surface area of the heat reactive material may be increased at least twice, or at least three times, or at least four times, or at least five times, or at least six times, or at least seven times, or at least eight times, or at least nine times, or at least eleven times, or at least twelve times, or at least thirteen times, or at least fourteen times, or at least fifteen times after expansion.

Tendrils may extend outward from the expanded heat reactive material. Where the heat reactive material is situated on the layer(s) in a discontinuous form, the tendrils may extend to at least partially fill the open areas between the discontinuous domains of the heat reactive material. The tendrils may be elongated and may have a length to width aspect ratio of at least 5 to 1.

In embodiments in which the heat reactive material comprising a polymer resin-expandable graphite mixture is applied in a pattern of discontinuous forms, the heat reactive material may expand forming tendrils that are loosely packed after expansion creating voids between the tendrils, as well as space between the pattern of the heat reactive material. Without wishing to be bound by theory, upon exposure to the heat from an electric arc, each of the first and second meltable layer melts and generally moves away from the open areas between the discontinuous forms of the heat reactive material.

The heat reactive material may act as the adhesive material between the first meltable layer and the first barrier layer as well as between the second meltable layer and the second barrier layer.

The heat reactive material may be prepared by a method that provides an intimate blend of polymer resin and expandable graphite, without causing substantial expansion of the expandable graphite. The polymer resin and an expandable graphite may be blended to form a mixture that can be applied in a continuous or a discontinuous pattern to a surface interface, that is, at least one surfaces of the first meltable layer and the first barrier layer; as well as at least one of the surfaces of the second meltable layer and the second barrier layer. In this way, the layers of the first and second heat reactive materials can act as an adhesive, attaching or bonding the layers of the first meltable layer to the first barrier layer and attaching or bonding the second meltable layer to the second barrier layer. A polymer resin and expandable graphite mixture may be prepared by any suitable mixing method. Suitable mixing methods include but not limited to paddle mixer, blending and other low shear mixing techniques.

The heat reactive material comprising the polymer resin and expandable graphite may be prepared by mixing the expandable graphite with a monomer or prepolymer prior to polymerization of the polymer resin. In other embodiments, the heat reactive material may be prepared by blending the expandable graphite with the polymer resin dissolved in a solvent, wherein at least a portion of the solvent is removed after mixing. In other embodiments, the heat reactive material may be prepared by mixing expandable graphite with a polymer melt at a temperature below the expansion temperature of the graphite and above the melting temperature of the polymer. Without wishing to be bound by theory, a mixture prepared by these methods may comprise an intimate blend of polymer resin and expandable graphite particles.

In methods which provide an intimate blend of polymer resin and expandable graphite particles or agglomerates of expandable graphite, the expandable graphite is coated or encapsulated by the polymer resin prior to expansion of the graphite. The intimate blend of polymer resin and expandable graphite may be prepared prior to applying the heat reactive material to the first or second meltable layer or to the first or second barrier layer.

The heat reactive material may comprise less than or equal to about 50 wt % of expandable graphite, based on the total weight of the heat reactive material. In other embodiments, the heat reactive material may comprise less than or equal to about 40 wt %, or less than or equal to about 30 wt %, or less than or equal to about 20 wt %, or less than or equal to about 10 wt %, or less than or equal to about 5 wt %, or greater than or equal to about 1 wt % of the expandable graphite, based on the total weight of the heat reactive material, and the balance substantially comprising the polymer resin. Generally, from about 5 wt % to about 50 wt % of expandable graphite based on the total weight of the heat reactive material, is desired. However, desirable flame resistance performance may be achieved with even lower amounts of expandable graphite. In some embodiments, loadings as low as 1 wt % may be useful. Depending on the properties desired and the construction of the resulting laminate structures, other levels of expandable graphite may also be suitable for other embodiments. Other additives such as pigments, fillers, antimicrobials, processing aids and stabilizers may also be added to the heat reactive material.

The first laminate comprises a first meltable layer and a first barrier layer, with a layer of the first heat reactive material as an adhesive between the two layers. The first layer of heat reactive material may be applied to one side of the first meltable layer and/or one side of the first barrier layer. The second layer of heat reactive material may be applied to one side of the second meltable layer and/or one side of the second barrier layer.

The first and/or the second layers of heat reactive material may independently be applied continuously or discontinuously. For example, where enhanced breathability and/or hand is desired, both of the layers of heat reactive material may be applied discontinuously to form a layer of heat reactive material having less than 100% surface coverage. A discontinuous application of the layers of heat reactive material may provide less than 100% surface coverage to the meltable textiles and the barrier layers.

The layers of heat reactive material may be applied discontinuously in one or more patterns. The heat reactive material may be applied to the first meltable layer or the first barrier layer and to the second meltable layer or to the second barrier layer forming individual layers of heat reactive material in the form of a multiplicity of discrete pre-expansion structures. Upon expansion, the discrete pre-expansion structures may form a multiplicity of discrete expanded structures having structural integrity. The multiplicity of discrete expanded structures having structural integrity may provide sufficient protection to the multilayer textile composite to achieve the enhanced properties described herein. By structural integrity it is meant that the heat reactive material after expansion withstands flexing or bending without substantially disintegrating or flaking off and withstands compression upon thickness measurement when measured according to the Thickness Change Test described herein.

The layers of heat reactive material may be applied discontinuously in a pattern comprising a multiplicity of discrete pre-expansion structures comprising the heat reactive material. The pattern may include shapes such as dots, circles, rhomboids, ovals, stars, rectangles, squares, triangles, pentagons, hexagons, octagons, lines, waves, and the like, and combinations thereof.

The average distance between adjacent areas of the discontinuous pattern of the heat reactive material may be less than the size of an impinging flame. The average distance between adjacent areas of discontinuous pattern may be equal or less than about 10 millimeters (mm), or equal or less than about 9 mm, or equal or less than about 8 mm, or equal or less than about 7 mm, or equal or less than about 6 mm, or equal or less than about 5 mm, or equal or less than about 4 mm, or equal or less than about 3.5 mm, or equal or less than about 3 mm, or equal or less than about 2.5 mm or equal or less than about 2 mm, or equal or less than about 1.5 mm, or equal or less than about 1 mm, or equal or less than about 0.5 mm, or equal or less than about 0.4 mm, or equal or less than about 0.3 mm, or equal or less than about 0.2 mm. For example, in a dotted pattern printed of the heat reactive material, the spacing between the edges of two adjacent dots of heat reactive material would be measured. An average distance between adjacent areas of the discontinuous pattern may be equal or greater than about 40 microns, or equal or greater than about 50 microns, or equal or greater than about 100 microns, or equal or greater than about 200 microns, depending on the application. Average dot spacing measured to be equal or greater than about 200 microns and equal or less than about 500 microns is useful in some patterns described herein.

Pitch may be used, for example, in combination with surface coverage as a way to describe the laydown of a printed pattern. In general, pitch is defined as the average center-to-center distances between adjacent forms such as dots, lines, or gridlines of the printed pattern. The average is used, for example, to account for irregularly spaced printed patterns. The heat reactive material may be applied discontinuously in a pattern with a pitch and surface coverage that provides superior flame retardant performance compared to a continuous application of heat reactive mixture having a laydown of equivalent weight of the heat reactive material. The pitch may be defined as the average of the center-to-center distances between adjacent shapes of the heat reactive material. For example, the pitch may be defined as the average of the center-to-center distances between adjacent dots or grid lines of the heat reactive material. The pitch may be equal or greater than about 500 microns, equal or greater than about 600 microns, equal or greater than about 700 microns, equal or greater than about 800 microns, equal or greater than about 900 microns, equal or greater than about 1000 microns. equal or greater than about 1200 microns, equal or greater than about 1500 microns, equal or greater than about 1700 microns, equal or greater than about 1800 microns, equal or greater than about 2000 microns, equal or greater than about 3000 microns, equal or greater than about 4000 microns, or equal or greater than about 5000 microns, or equal or greater than about 6000 microns or any value therebetween. A preferred pattern of heat reactive material may have pitch from about 500 microns to about 6000 microns.

In embodiments where properties such as hand, breathability, and/or textile weight are important, a surface coverage of equal or greater than about 25%, and equal or less than about 90%, or less than about 80%, or less than about 70%, or less than about 60%, or less than about 50%, or less than about 40%, or less than about 30% may be used. Upon exposure to an electric arc, the first meltable layer may be exposed to enough energy to combust. In those embodiments and where greater flame-resistant properties are needed, it may be desired to have a surface coverage from about 30% to about 100% of the heat reactive material on a surface of the first or second meltable layer. Where greater flame-resistant properties are needed, it may be desired to have a surface coverage of the heat reactive material with pitch from about 500 microns to about 6000 microns. For example, the surface coverage of the heat reactive material may be from about 30% to about 80% of the heat reactive material on a surface of the first or second meltable layers or on the first or second barrier layers with pitch from about 500 microns to about 6000 microns.

A method for depositing the heat reactive material discontinuously on the first or second meltable layers or on the first or second barrier layers achieving a coverage of the surface of less than 100% may comprise applying the heat reactive material by printing onto said layer. The deposition of the heat reactive material on the first or second meltable layers and/or the first or second barrier layer may be achieved by any suitable method, such as gravure printing, screen printing, spray or scatter coating, knife coating, and any like method that enables the heat reactive material to be applied in a manner in which the desired properties upon exposure to the heat from an electrical arc are achieved.

The heat reactive material may be applied to achieve an add-on weight of from about 10 gsm to about 100 gsm per layer of the heat reactive material. The heat reactive material may be applied to achieve an add-on weight of equal or less than about 100 gsm, or equal or less than about 75 gsm, or equal or less than about 50 gsm, or equal or less than about 25 gsm of the heat reactive material.

A method of fabricating the first and second laminates described herein may comprise applying a layer of heat reactive material to the first or second meltable layer and/or to the first or second barrier layer in an amount which the heat reactive material provides a good bond between the barrier layer and the respective meltable layer. The layers of the heat reactive material may function as an adhesive. For example, the heat reactive material may bond one side of the first meltable layer to one side of the first barrier layer forming a layer of heat reactive material between the first meltable layer and the first barrier layer. Likewise, the second layer of heat reactive material may bond one side of the second meltable layer to one side of the second barrier layer forming a second layer of heat reactive material between the second meltable layer and the second barrier layer.

During the formation of the first and/or second laminates, the layers of first and/or second heat reactive material may independently be applied in a continuous or discontinuous manner to the meltable layers and/or to the barrier layers. The first meltable layer and the first barrier layer may then be adhered to one another and the second meltable layer and the second barrier layers may then be adhered to each other. Optionally, each of the first and/or the second laminates may then be passed through the nip of two or more rollers to apply pressure and/or heat to help ensure a strong bond. If heat is used, the temperature should be low enough so that the heat does not initiate expansion of the expandable graphite. Application of pressure (e.g., from the rollers) may cause at least the polymer resin of the heat reactive material to be disposed at least partially within surface pores, surface voids or voids or spaces between the fibers of one or both of the layers. At least the polymer resin of the heat reactive material may penetrate the voids or spaces between the fibers and/or filaments of the meltable layers. In some embodiments, at least the polymer resin of the heat reactive material may penetrate into the barrier layer. In still further embodiments, at least the polymer resin of the heat reactive material may penetrate the voids or spaces between the fibers of the meltable layers and may also penetrate into the barrier layer.

### Barrier Layer

The multilayer textile composite also comprises the first barrier layer and, if present, the second barrier layer. The following descriptions of barrier layers are described in terms of the first barrier layer but are applicable to the second barrier layer, as well. In some embodiments, the barrier layers are in the form of a film. Each of the barrier layers may independently comprise a layer of polyimide, silicone, polytetrafluorethylene (PTFE), expanded polytetrafluoroethylene (ePTFE), polyolefin, polyethylene, polypropylene, or a combination thereof. In some embodiments, the first and the second barrier layers may comprise expanded polytetrafluoroethylene (ePTFE).

The first and/or the second barrier layer may independently be a single layer film, a two-layer film, a three-layer film, or a multilayer film. Suitable single layer films can comprise a layer of microporous expanded polytetrafluoroethylene film, a polyimide film, a silicone film, or a polytetrafluoroethylene film. In some embodiments, the barrier layer may be a multilayer film comprising a microporous expanded polymer film comprising micropores and another polymer filling at least a portion of the pores of the expanded polymer film, and optionally forming a cap layer or a film layer on one or both sides of the microporous expanded polymer film.

In some embodiments, a two-layer barrier layer may comprise a first layer of microporous expanded polytetrafluoroethylene and a second layer of microporous expanded polytetrafluoroethylene. In other embodiments, a two-layer barrier layer may comprise a first layer of microporous expanded polytetrafluoroethylene and a polyurethane coating on the layer of microporous expanded polytetrafluoroethylene, wherein the polyurethane layer is a coating on the surface of the microporous ePTFE and/or the polyurethane fills at least a portion of the pores of the microporous ePTFE layer. In other embodiments, a 3-layer barrier layer may comprise a layer of polyurethane in between two layers of microporous ePTFE. In some 3-layer embodiments, the layer of polyurethane at least partially penetrates the pores of one or both of the layers of the microporous ePTFE. In other embodiments, the first and/or second barrier layer can be a layer of a microporous expanded polyolefin film with a layer of a polyurethane coated on the microporous expanded polyolefin film. The polyurethane may penetrate at least a portion of the pores of the microporous expanded polyolefin film and/or may form a cap layer on top of the polyolefin film. In other embodiments, the first and/or second barrier layer can be a layer of a microporous expanded polyethylene film with a layer of a polyurethane coated on the microporous expanded polyethylene film. The polyurethane may penetrate at least a portion of the pores of the microporous expanded polyethylene film and/or may form a cap layer on top of the microporous expanded polyethylene film.

The barrier layer may be a film having a thickness of equal or less than 1 millimeter (mm) and a hand of equal or less than about 100, when measured by the Flexibility or Hand Measurement Test described herein.

The barrier layer may be a thermally stable barrier layer. In some embodiments, the barrier layer is a thermally stable barrier layer, as measured by the Barrier Thermal Stability Test described herein. The barrier layers may be more thermally stable than the first and/or second meltable layers and/or any of the first, second, third or fourth flame retardant textiles that might be present. A thermally stable barrier layer can help to prevent the heat transfer from one (outer) side of the multilayer textile composite to another (inner) side of the multilayer textile composite, for example from the first portion to the second portion, during exposure to an electrical arc. Thermally stable barrier layers for use as the barrier layer in the embodiments described herein, have a maximum air permeability of about 50 liters/meter²/second (l/m²/sec) after thermal exposure when tested according to the air permeability test ISO 9237 (1995). Thermally stable barrier layers for use as the barrier layer in the embodiments described herein, are also resistant to forming holes (greater than or equal to 5 millimeters in diameter) after exposure to an electric arc. In other embodiments, the barrier layers have a maximum air permeability of less than about 25 l/m²/sec or less than about 15 l/m²/sec, after thermal exposure, when tested according to the air permeability test for thermally stable barrier layer as disclosed herein. Where the barrier layer comprises a film, the film may have a maximum air permeability of equal or less than about 25 l/m²/sec after thermal exposure when tested as per the Melting and Thermal Stability Test method described herein. Where the barrier layer comprises a film, the film may have an air permeability after an electrical arc exposure sufficient to expand the expandable graphite of equal or less than about 15 I/m²/sec, when tested according to the air permeability test for thermally stable barriers as disclosed herein.

The barrier layer may have a maximum air permeability of equal or less than about 50 l/m²/sec, or equal or less than about 45 l/m²/sec, or equal or less than about 40 I/m²/sec, or equal or less than about 35 l/m²/sec, or equal or less than about 30 l/m²/sec, or equal or less than about 25 l/m²/sec, or equal or less than about 20 l/m²/sec, or equal or less than about 15 l/m²/sec, or equal or less than about 10 l/m²/sec, or equal or less than about 5 l/m²/sec, after thermal exposure when tested according to the air permeability test for thermally stable barrier layer as disclosed herein.

The barrier layer may have a weight in the range of from 4 grams per square meter (gsm) to 60 gsm, or in the range of from 5 gsm to 55 gsm, or in the range of from 6 gsm to 50 gsm, or in the range of from 8 gsm to 50 gsm, or in the range of from 10 gsm to 50 gsm, or in the range of from 10 gsm to 45 gsm, or in the range of from 10 gsm to 40 gsm, or in the range of from 10 gsm to 35 gsm, or in the range of between 30 gsm and 40 gsm, or in the range of between 20 gsm and 30 gsm, or in the range of between 15 gsm and 35 gsm, or in the range of between 20 gsm and 35 gsm, or in the range of between 25 gsm and 35 gsm, or in the range of between 30 gsm and 35 gsm, or in the range of between 15 gsm and 30 gsm, or in the range of between 25 gsm and 30 gsm, or in the range of between 15 gsm and 25 gsm, or in the range of between 20 gsm and 25 gsm, or in the range of between 15 gsm and 20 gsm, or in the range of between 21 gsm and 23 gsm, or in the range of between 29 gsm and 31 gsm, or any value therebetwen or about 22 gsm, or about 30 gsm.

### Flame Retardant Textile

The present disclosure describes a first flame retardant textile, a second flame retardant textile, a third flame retardant textile and a fourth flame retardant textile. Each of these flame retardant textiles are individual layers that may be present in the multilayer textile composite and the following description of flame retardant textiles is suitable to describe each of the individual flame retardant textiles that can be used in any of the portions. Each flame retardant textile can be chosen independently of the other flame retardant textiles, if present. Therefore, each flame retardant textile can be the same or different.

The first portion can comprise a first flame retardant textile. The first flame retardant textile can be adjacent to the first barrier layer. Suitable flame retardant textiles can comprise fibers or yarns made from inherently flame-retardant materials, from materials that have been treated with one or more flame retardant agents to be made flame retardant or from a combination thereof. Suitable materials can include, for example, aramids, p-aramid, m-aramid, polybenzimidazole (PBI), polybenzoxazole (PBO), polyetheretherketone, polyetherketoneketone, polyphenylene sulfide, polyimide, polyamide imide, melamine, fluoropolymer, polytetrafluoroethylene, modacrylic, cellulose, FR cellulose, FR viscose, polyvinylacetate, polyacrylonitrile, carbon, mineral, protein fibers, or a combination thereof. In some embodiments, a small proportion, for example, less than 10% by weight of antistatic fibers or filaments may be added to the textile, wherein the percentage by weight of the antistatic fibers or filaments is based on the total weight of the flame retardant textile. Suitable antistatic fibers/filaments are known in the art and can include, for example, conductive metals, copper, nickel, stainless steel, steel, gold, silver, titanium, carbon fibers.

The flame retardant textile can have a weight in the range of from 100 grams per square meter (gsm) to about 300 gsm. In other embodiments, the flame retardant textile can have a weight in the range of from 100 gsm to about 275 gsm, or from 100 gsm to about 250 gsm, or from 100 gsm to about 240 gsm, or from 100 gsm to about 230 gsm, or from 100 gsm to about 225 gsm, or from 100 gsm to about 220 gsm.

When the first flame retardant textile is part of the first laminate, it can be attached to the first barrier layer via a flame retardant adhesive. The flame retardant adhesive can be any textile adhesive that is known the art. Typically, one or more flame retardant agents can be added to the adhesive to provide flame resistance. Typical flame retardant agents include, for example, phosphorous-based flame retardants, amine-based flame retardants, other known flame retardant agents or a combination thereof.

### Second Portion

The multilayer textile composite further comprises a second portion. In some embodiments, the second portion is adjacent to the first portion and is attached to the first portion via one or more stitches. In other embodiments, a third portion is located between the first portion and the second portion, wherein at least a portion of the first, second, and third portions are attached via the one or more stitches.

The second portion can comprise b) the second laminate, wherein the second laminate comprises b1) the second meltable layer; b2) the second layer of heat reactive material; b3) the second barrier layer; and optionally b4) the second flame retardant textile; or the second portion can comprise the third flame retardant textile. In some of the prior embodiments, the second portion can be adjacent to the first barrier layer of the first portion. In embodiments where the second portion is the third flame retardant textile, the third flame retardant textile is adjacent to the first barrier layer. In embodiments where the second portion is a second laminate, the second meltable layer of the second portion is adjacent to the first barrier layer of the first portion. The second flame retardant textile can be adhered to the second barrier layer by one or more of the flame retardant adhesives described previously.

When the second portion is the third flame retardant textile, the third flame retardant textile can be a woven, knit or nonwoven textile comprising fibers, for example. aramids, p-aramid, m-aramid, polybenzimidazole (PBI), polybenzoxazole (PBO), polyetheretherketone, polyetherketoneketone, polyphenylene sulfide, polyimide, polyamide imide, melamine, fluoropolymer, polytetrafluoroethylene, modacrylic, cellulose, FR cellulose, FR viscose, polyvinylacetate, polyacrylonitrile, carbon, mineral, protein fibers, or a combination thereof. In some embodiments, a small proportion, for example, less than 10% by weight of antistatic fibers or filaments may be added to the third flame retardant textile, wherein the percentage by weight of the antistatic fibers or filaments is based on the total weight of the third flame retardant textile. Suitable antistatic fibers/filaments are known in the art and can include, for example. conductive metals, copper, nickel, stainless steel, steel, gold, silver, titanium, carbon fibers.

When the second portion is a second laminate, the second meltable layer, the second layer of heat reactive material and the second barrier layer can independently use any of the materials as described for each of the first meltable layer, the first layer of heat reactive material and/or the first barrier layer, respectively. For example, the first meltable layer can be a polyester woven textile and the second meltable layer can be another layer of the same polyester woven textile or the second meltable layer can be a polyamide knit textile. In other words, any of the materials described for the first meltable layer can independently be used for the second meltable layer; any of the materials described for the first layer of heat reactive material can independently be used for the second layer of heat reactive material, and any of the materials described for the first barrier layer can independently be used for the second barrier layer. In some embodiments, the first and second meltable layers are the same. In some embodiments, the first and second layers of heat reactive material are the same. In some embodiments, the first and second barrier layers are the same. In some embodiments, the first and second meltable layers are different. In some embodiments, the first and second layers of heat reactive materials are different. In some embodiments, the first and second barrier layers are different.

If desired, the second laminate can further comprise b4) the second flame retardant textile. Any of those materials that were described for the first flame retardant textile. For example, the second flame retardant textile can comprise one or more of aramids, p-aramid, m-aramid, polybenzimidazole (PBI), polybenzoxazole (PBO), polyetheretherketone, polyetherketoneketone, polyphenylene sulfide, polyimide, polyamide imide, melamine, fluoropolymer, polytetrafluoroethylene, modacrylic, cellulose, FR cellulose, FR viscose, polyvinylacetate, mineral, protein fibers, or a combination thereof. One or more of the previously described antistatic fibers may be present in the second flame retardant textile in an amount of 10% by weight or less, based on the total weight of the second flame retardant textile. If present, the first and second flame retardant textile can be the same or can be different.

The second flame retardant textile can be adhered to the second barrier layer via an adhesive, preferably, an adhesive comprising a flame retardant additive, as was described previously. Suitable textile adhesives and flame retardant containing adhesives are known in the art and can comprise, for example, polyurethane adhesive, polyester adhesive, acrylic adhesives, or a combination thereof.

The second laminate is positioned and attached to the first portion so that the first barrier layer is oriented to be adjacent to the second meltable layer. In some embodiments, there is no third portion between the first barrier layer and the second meltable layer. In some embodiments, a third portion is present between the first portion and the second portion. In some embodiments, stitches are used to attach at least one layer of the first portion to at least one layer of the second portion.

### Third Portion

The multilayer textile composite may further comprise a third portion. In some embodiments of the multilayer textile composite, the third portion is present. In some embodiments of the multilayer textile composite, is free from the third portion. The third portion comprises a fourth flame retardant textile, is located between the first portion and the second portion and is attached to the multilayer textile composite via the one or more stitches.

The third portion comprises the fourth flame retardant textile. The fourth flame retardant textile can be a knit, a woven, a nonwoven or a multilayered combination thereof. Suitable flame retardant textile can comprise for example, aramids, p-aramid, m-aramid, polybenzimidazole (PBI), polybenzoxazole (PBO), polyetheretherketone, polyetherketoneketone, polyphenylene sulfide, polyimide, polyamide imide, melamine, fluoropolymer, polytetrafluoroethylene, modacrylic, cellulose, FR cellulose, FR viscose, polyvinylacetate, mineral, protein fibers, or a combination thereof. One or more of the previously described antistatic fibers may be present in the second flame retardant textile in an amount of 10% by weight or less, based on the total weight of the second flame retardant textile. If present, the first, second, third and fourth flame retardant textile can be the same or can be different.

### Stitches

The first portion, the second portion and optional third portion are attached to one another via one or more stitches. The stitches are sewn stitches and can be machine-stitched, hand-stitched, or a combination thereof. The stitches comprise one or more of quilting stitches, a series of one or more stitch lines, a series of overlapping stitch lines, a series of stitched geometric shapes, a series of stitches in a grid pattern, a series of stitches that are essentially parallel to each other, a series of tack stitches, or a combination thereof.

The stitching forms a connection or an attachment between the portions wherein a side of the first portion, for example, the first barrier layer, contacts a side of the second portion, for example, the second meltable layer. In embodiments where a third portion is present, the third portion is located between the first portion and the second portion and is attached to the first and second portions via the stitches. In some embodiments (as exemplary shown in FIG. 4) one side of the third portion contacts the first barrier layer of the first portion and the opposite side of the third portion contacts the second portion. The quilting stitches penetrate the first meltable layer, the first layer of heat reactive material, the first barrier layer and both the third portion and the second portion. When the second portion is a second laminate (as exemplary shown in FIG. 5), the first barrier layer contacts one side of the third portion and the opposite side of the third portion contacts the second meltable layer of the second portion. In other embodiments comprising a third portion, the first flame retardant layer contacts one side of the third portion and the opposite side of the third portion contacts the second portion.

The stitches create areas of connection between the two portions and are spaced apart so as to have land areas of the first and second portions that are not intimately connected. The stitches should be spaced sufficiently far apart so as to provide land areas between the stitches in the range of from about 1 centimeter² (cm²) to about 1500 cm². In other embodiments, the land area can be in the range of from 1 to 1400 cm², or from 1 to 1300 cm², or from 1 to 1250 cm², or from 1 to 1200 cm², or from 1 to 1150 cm², or from 1 to 1100 cm², or from 1 to 1050 cm², or from 1 to 1000 cm², or from 1 to 950 cm², or from 1 to 900 cm², or from 1 to 850 cm², or from 1 to 800 cm², or from 1 to 750 cm², or from 1 to 700 cm², or from 1 to 650 cm², or from 1 to 600 cm², or from 1 to 550 cm², or from 1 to 500 cm², or from 1 to 450 cm², or from 6 to 1250 cm², or from 6 to 1200 cm², or from 6 to 1150 cm², or from 6 to 1100 cm², or from 6 to 1050 cm², or from 6 to 1000 cm², or from 6 to 950 cm², or from 6 to 900 cm², or from 6 to 850 cm², or from 6 to 800 cm², or from 6 to 750 cm², or from 6 to 700 cm², or from 6 to 650 cm², or from 6 to 600 cm² or from 6 to 550 cm², or from 6 to 500 cm², or from 6 to 450 cm². The phrase “land area” means the area of a layer between stitch lines that forms the unattached area between layers. In some embodiments, for example, a quilt stitch, the land area is the area bounded by the stitch. In other embodiments, for example, a series of tack stitches, the land area can be determined by analyzing the repeat pattern or patterns of the stitches, and determining the area encompassed by each repeat unit, (as exemplary shown in FIG. 7) which shows a regular repeating pattern of tack stitches, forming a series of rectangular land areas, with the distance between each tack stitch having a land height and a land width. The land area, in this example, is the land height multiplied by the land width.

The stitches can penetrate the entire thickness of the multilayer textile composite. For example, and as shown in exemplary FIGS. 1, 2 and 3, the stitch may penetrate the entire thickness of the multilayer textile composite from the first meltable layer to the second portion. For example, FIG. 1 shows the stitch penetrating the entire thickness from the first meltable layer to the FR textile layer. FIG. 2 shows the stitch penetrating from the first meltable layer to the second barrier layer. FIG. 3 shows the stitch penetrating the entire thickness from the first meltable layer to the second FR textile of the second laminate. In other embodiments, the stitches may penetrate less than the full thickness of the multilayer textile composite, for example, penetrating only certain layers of the multilayer textile composite, typically connecting at least the first barrier layer and the second meltable textile or the second flame retardant textile. As shown in FIG. 6, a first barrier layer can be stitched to a second meltable textile with the remainder of the multilayer textile composite adhered via one or more adhesive layers. Once the first barrier layer and the second meltable textile have been stitched together, standard lamination techniques can be used to form the remainder of the multilayer textile composite. In some embodiments, by applying the first or the second layer of heat reactive material to the first barrier layer or the second meltable textile, followed by application of the first meltable layer or the second barrier layer can form a portion of the multilayer textile composite. The process can then be repeated for the remaining layer, to form the multilayer textile composite. While this process has been described for a first portion and a second portion, the process can be used with any of the combinations of first portion, second portion and third portion, stitching at least one portion of the first portion to at least one portion of the second portion, with or without a third portion in between the first and second portions.

The stitching itself can be any materials that are commonly used to make sewing threads. In some embodiments, the stitching can be one or more of flame-retardant fibers in the form of a sewing thread. Any of those materials that are described as useful for making flame retardant textiles can be used to make the stitching material. For example, the thread can be aramids, p-aramid, m-aramid, polybenzimidazole (PBI), polybenzoxazole (PBO), polyetheretherketone, polyetherketoneketone, polyphenylene sulfide, polyimide, polyamide imide, melamine, fluoropolymer, polytetrafluoroethylene, modacrylic, cellulose, FR cellulose, FR viscose, polyvinylacetate, mineral, protein fibers, or a combination thereof. Threads for sewing can also be threads that have a core/shell structure comprising a core of any of the flame-retardant fibers with a shell of a meltable fiber, for example, polyamide, polyester, polyolefin, acrylic, polyurethane, or a combination thereof. In other embodiments, the core can be a meltable fiber, for example, a polyester or a polyamide and the shell can be a flame retardant fiber.

### Method of Making the Textile Composite

The multilayer textile composite comprising the first portion and the second portion can be made in a number of ways. The first portion comprising the first laminate comprising the first meltable layer, the first layer of heat reactive material, the first barrier layer, and, in some embodiments, the first flame retardant textile. In some embodiments, the second portion comprise the second laminate comprising the second meltable layer, the second layer of heat reactive material, the second barrier layer, and optionally, the second flame retardant textile layer. In other embodiments, the second portion can comprise the third flame retardant textile. The first portion comprising the first laminate can be produced by selecting the first meltable layer, the first heat reactive material and the first barrier layer. The first laminate can be made using standard lamination techniques of applying the first layer of heat reactive material to one or both of the first meltable layer and/or the first barrier layer. The application of the layer of the first heat reactive material can be done using printing and/or coating techniques, for example, gravure printing, screen printing, flow coating, knife coating, etc. After the application of the first layer of heat reactive material, the first meltable layer and the first barrier layer can be brought in contact with each other so that the first layer of heat reactive material is sandwiched between the first meltable layer and the first barrier layer, adhering the two layers together. Optionally, pressure and/or heat can be applied to form the first portion comprising the first laminate. If desired, the second portion comprising the second laminate can be formed using similar lamination processes. In some embodiments, the first laminate and the second laminate are identical laminates. In other embodiments, the second laminate has at least one layer that is different from the first laminate.

The first portion can then be attached to the second portion by one or more stitches, so that the first barrier layer is in contact with the second portion. In embodiments where the second portion is a second laminate, the first barrier layer is adjacent to and in contact with the second meltable layer. In some embodiments, there is no third portion between the first barrier layer and the second meltable layer. In embodiments where the second portion is a flame retardant textile, the first barrier layer is adjacent to the flame retardant textile. In some embodiments, the third portion is located between the first portion and the second portion. In some embodiments, the multilayer textile composite comprises the third portion is located between and in contact with the first barrier layer and the second meltable layer. In other embodiments, the multilayer composite textile comprises the third portion between the first barrier layer and the second flame retardant textile.

The stitching process can comprise hand-sewn stitches, machine-sewn stitches or a combination thereof. The stitches can be continuous stitches utilizing a variety of patterns to create an attachment between the first and second portions and land areas that comprise the regions of the first and second portions in between the stitches. In some embodiments, the stitches are quilting stitches, a series of stitched geometric shapes, a series of stitches in a grid pattern, a series of stitches that are essentially parallel to each other, a series of tack stitches, or a combination thereof. Any quilting stitch can be used providing that the quilting stiches provide the necessary land area sizes as described herein. In other embodiments, the stitches can also be tack stitches, or non-continuous stitches. The tack stitches can comprise a regular series of repeating stitches wherein the stitches are not continuous stitches, (as exemplary shown in FIG. 7). When using tack stitches, the land area can be determined as the area bounded by the repeating pattern of tack stitches. the land area can be determined by analyzing the repeat pattern or patterns of the stitches, and determining the area encompassed by each repeat unit. FIG. 7, which shows a regular repeating pattern of tack stitches, forming a series of rectangular land areas, with the distance between each tack stitch having a land height and a land width. The land area, in this example, is the land height multiplied by the land width. In either embodiment, i.e., continuous stitches or non-continuous stitches, each land area can have an area that is in the range of from 1 centimeter² (cm²) to 1500 cm². In some embodiments, the land area can be in the range of from 6 cm² to about 1500 cm². In other embodiments, the land area can be in the range of from 1 to 1400 cm², or from 1 to 1300 cm², or from 1 to 1250 cm², or from 1 to 1200 cm², or from 1 to 1150 cm², or from 1 to 1100 cm², or from 1 to 1050 cm², or from 1 to 1000 cm², or from 1 to 950 cm², or from 1 to 900 cm², or from 1 to 850 cm², or from 1 to 800 cm², or from 1 to 750 cm², or from 1 to 700 cm², or from 1 to 650 cm², or from 1 to 600 cm², or from 1 to 550 cm², or from 1 to 500 cm², or from 1 to 450 cm², or from 6 to 1250 cm², or from 6 to 1200 cm², or from 6 to 1150 cm², or from 6 to 1100 cm², or from 6 to 1050 cm², or from 6 to 1000 cm², or from 6 to 950 cm², or from 6 to 900 cm², or from 6 to 850 cm², or from 6 to 800 cm², or from 6 to 750 cm², or from 6 to 700 cm², or from 6 to 650 cm², or from 6 to 600 cm² or from 6 to 550 cm², or from 6 to 500 cm², or from 6 to 450 cm².

### Uses

The multilayer textile composite described herein can be used to form a garment, wherein the first portion, specifically, the first meltable layer is positioned on an exterior side of the garment and the second portion is positioned on an inner side of the garment. In some embodiments, the garment can be a jacket, a shirt, gloves, pants, coveralls, overalls, footwear, head covering, a hat or any combination thereof. Depending on the construction, garments comprising the multilayer textile composite can protect a wearer from electric arc discharges that produce greater than or equal to 40 cal/cm². In other embodiments, the garments can provide a wearer from electric arc discharges that produce greater than 75 cal/cm², or from greater than 90 cal/cm², or from greater than 100 cal/cm². The garments can provide protection from high energy arc discharges while providing a relatively lightweight garment.

### BRIEF DESCRIPTION OF THE FIGURES

FIG. 1 shows an embodiment of the multilayer textile composite wherein the second portion is a flame retardant textile.

FIG. 2 shows an embodiment of the multilayer textile composite wherein the second portion is a second laminate.

FIG. 3 shows an embodiment of the multilayer textile composite wherein the second portion is a second laminate.

FIG. 4 shows an embodiment of the multilayer textile composite having a second portion, and a third portion, the third portion positioned between the first portion and the second portion.

FIG. 5 shows an embodiment of the multilayer textile composite having a first portion, a second portion and a third portion, wherein the second portion is a second laminate.

FIG. 6 shows an embodiment of the multilayer textile composite having a first portion and a second portion, wherein the second portion is a second laminate, and the quilting stitches connect a portion of the first portion to a portion of the second laminate.

FIG. 7 shows an embodiment of the multilayer textile composites using tack stitches.

### DETAILED DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments of the invention may be readily combined, without departing from the scope or spirit of the invention.

The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The terms “fiber” and “filament” are used interchangeably herein. Fibers and filaments have a relatively small width and height compared to their length. The cross-section of fibers and filaments can be round, square or virtually any shaped, including those having one or more lobes, and are well-known in the art. Typically, a fiber has a relatively short length, for example, less than or equal to 30 centimeters, while a filament has a length greater than 30 centimeters and can essentially be endless, for example, thousands of meters long.

As used herein, the term “meltable”, when used in relation to a fiber, a filament, a yarn, or a textile, means a fiber that melts at less than or equal to 280° C. or less than or equal to 300° C. In embodiments wherein the yarn or textile is made from a singular material, for example, 100% nylon 6, the melting point of the material is the melting point of the nylon 6. However, in yarn or textile embodiments comprising a mixture of both meltable and non-meltable fibers, the presence of the non-meltable component may mask the melting of the meltable material. For example, in the case of a textile comprising a 50/50 blend of nylon 6,6 and cotton, the melting nylon 6,6 may be absorbed by the cotton component and, when subjected to the melting and thermal stability test described herein, may appear to show that the textile sample is not meltable. Therefore, the presence of a meltable fiber in a blend of meltable and non-meltable fibers makes the fiber, filament, yarn, or textile a meltable material for the purposes of this disclosure.

The terms “inner” and “outer” when used to describe layers of the laminate structure are intended to denote the positions of the first portion and second portion relative to one another and to the third portion and are based on the placement of the individual layers in a finished article. In a finished article, for example, a garment, such as a jacket, the first meltable textile is meant to be the outermost layer of the garment, whereas the second portion is meant to be the innermost layer, closest to the body of a wearer.

As used herein, the term “quilting” refers to a process of joining two materials by stitching the two or more of the layers together with one or more threads in multiple rows, wherein the stitching holds the two materials together across at least a portion of their surfaces, while leaving other portions in contact with one another, but separable. The term “quilted” refers to the structure resulting from the quitting process.

As used herein, moisture vapor transmission rate (MVTR) is the measure of how much water vapor can pass through a square meter of a membrane within 24 hours. The greater the MVTR is, the higher the breathability.

The present disclosure is related to a multilayer textile composite. The multilayer textile composite is useful for garments that can provide a wearer with a relatively lightweight garment that can provide a relatively high level of protection from injury when the garment is exposed to a high energy arc flash discharge.

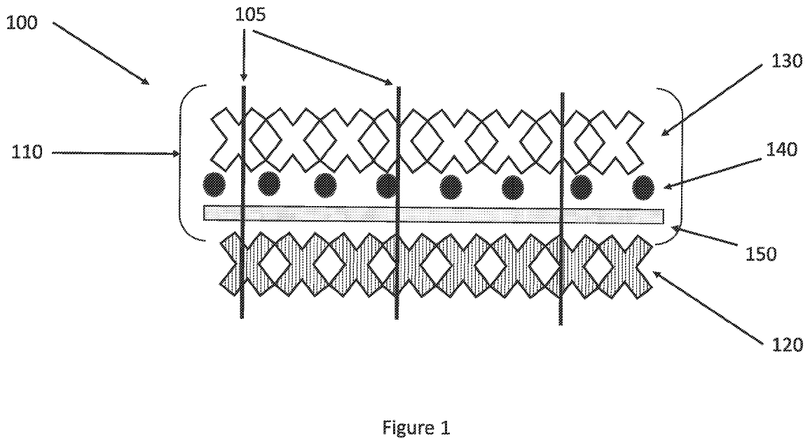

Embodiments of the multilayer textile composite can be seen in FIG. 1, which shows the multilayer textile composite 100, comprising a first portion 110 and a second portion 120. The first portion 110 comprises a first laminate comprising the first meltable layer 130, the first layer of the heat reactive material 140 and the first barrier layer 150. Stitches 105 are also shown. The stitches 105 are only shown as cross-sections. The stitches 105 may be quilted stitches or may be tack stitches. In this figure, the second portion 120 is represented as a first flame retardant textile.

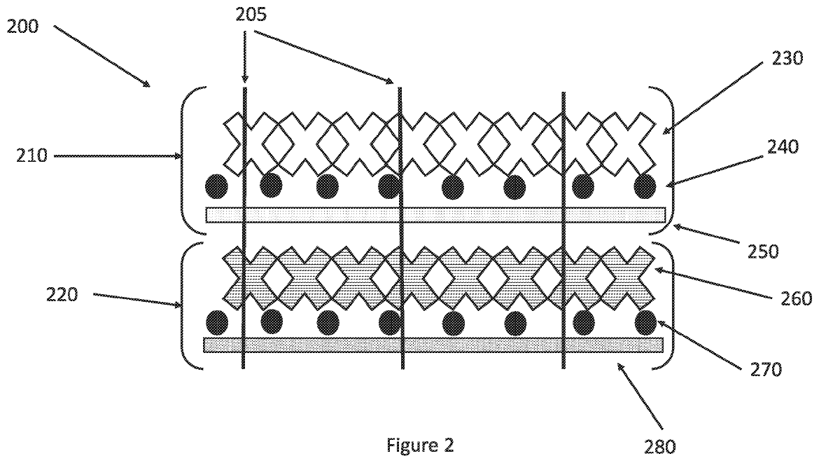

FIG. 2 shows another embodiment of the multilayer textile composite 200. In this embodiment, the multilayer textile composite 200 comprises a first portion 210 and a second portion 220. The first portion comprises a first laminate comprising the first meltable layer 230, the first layer of heat reactive material 240 and the first barrier layer 250. The second portion comprises a second laminate comprising the second meltable textile 260, the second layer of heat reactive material 270, and the second barrier layer 280. Individual stitches 205 are also shown in perspective that penetrate the entire thickness of the multilayer textile composite 200.

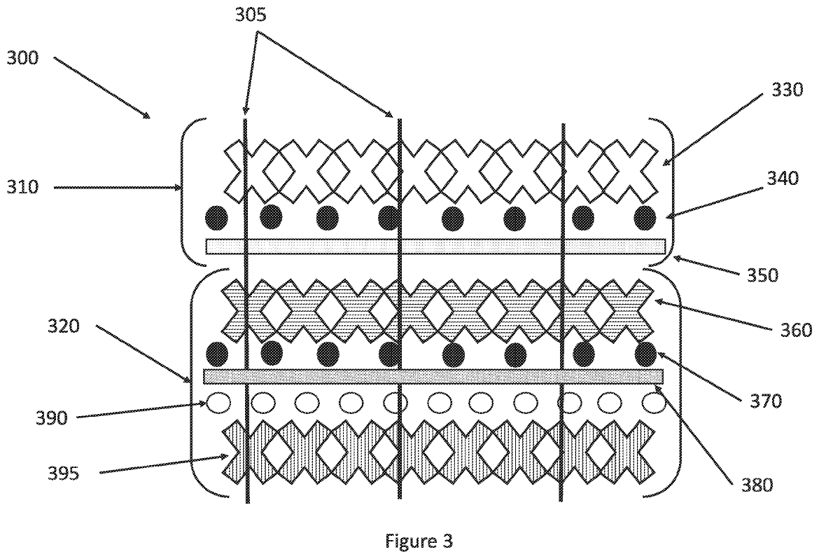

FIG. 3 shows another embodiment of the multilayer textile composite 300. In this embodiment, the multilayer textile composite 300 comprises a first portion 310 and a second portion 320. The first portion comprises the first laminate comprising the first meltable layer 330, the first layer of heat reactive material 340 and the first barrier layer 350. The second portion comprises a second laminate comprising the second meltable textile 360, the second layer of heat reactive material 370, the second barrier layer 380, the layer of adhesive 390 and the second flame retardant textile 395 opposite the adhesive 390. Stitches 305 are also shown that penetrate the entire thickness of the multilayer textile composite 300.

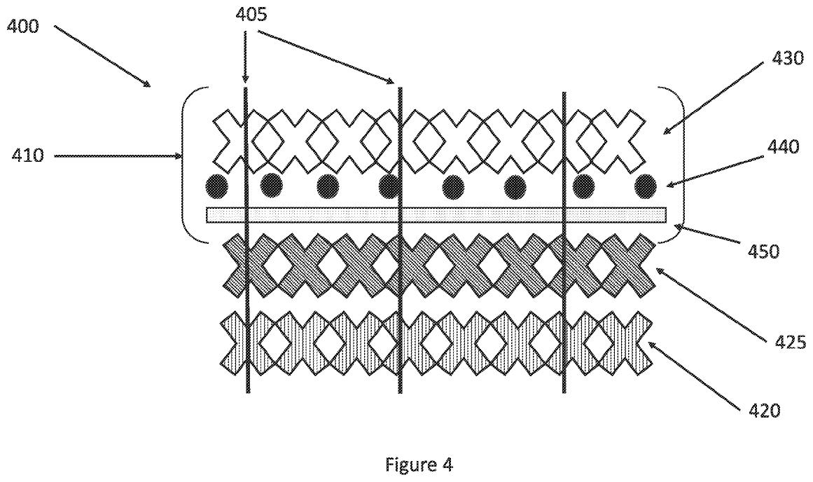

FIG. 4 shows another embodiment of the. In this embodiment, the multilayer textile composite 400 comprises a first portion 410, a second portion 420 and a third portion 425 in between the first portion 410 and the second portion 420. The first portion 410 comprises the first laminate comprising the first meltable textile 430, the first layer of heat reactive material 440 and the first barrier layer 450. The first barrier layer 450 is adjacent to one side of the third portion 425 and the opposite side of the third portion 425 is adjacent to the second portion 420. Stitches 405 penetrate the entire thickness of the multilayer textile composite 400. In this figure, the second portion 420 is represented as a second flame retardant textile and the third portion 425 is represented as the fourth flame retardant textile.

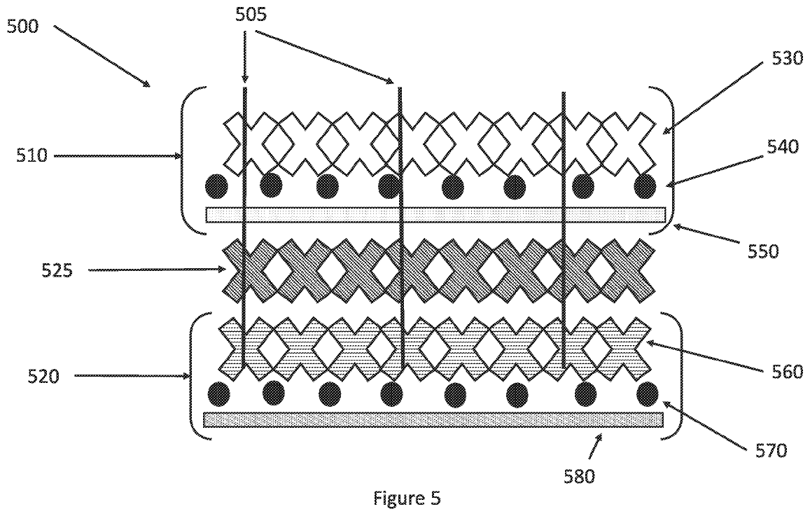

FIG. 5 shows another embodiment of the multilayer textile composite 500. In this embodiment, the first portion 510 comprises the first laminate comprising the first meltable textile 530, the first layer of heat reactive material 540, and the first barrier layer 550. The second portion 520 comprises the second laminate comprising the second meltable textile 560, the second layer of heat reactive material 570 and the second barrier layer 580. A third portion 525 is present. In this embodiment, one side of the third portion 525 is adjacent to the first barrier layer 550 and the opposite side of the third portion 525 is adjacent to the second meltable textile 560 of the second portion 520. Stitches 505 penetrate the entire thickness of the multilayer textile composite 500.

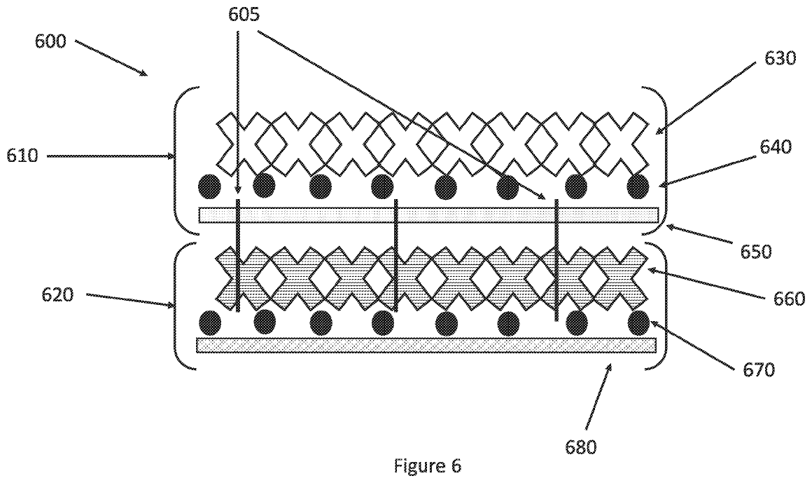

FIG. 6 shows another embodiment of the multilayer textile composite 600. In this embodiment, the multilayer textile composite 600 comprises the first portion 610 and the second portion 620. The first portion comprises the first laminate comprising the first meltable layer 630, the first layer of heat reactive material 640 and the first barrier layer 650. The second portion comprises the second laminate comprising the second meltable textile 660, the second layer of heat reactive material 670, and the second barrier layer 680. Stitches 605 are also shown, wherein the stitches 605 do not penetrate the entire thickness of the multilayer textile composite 600.

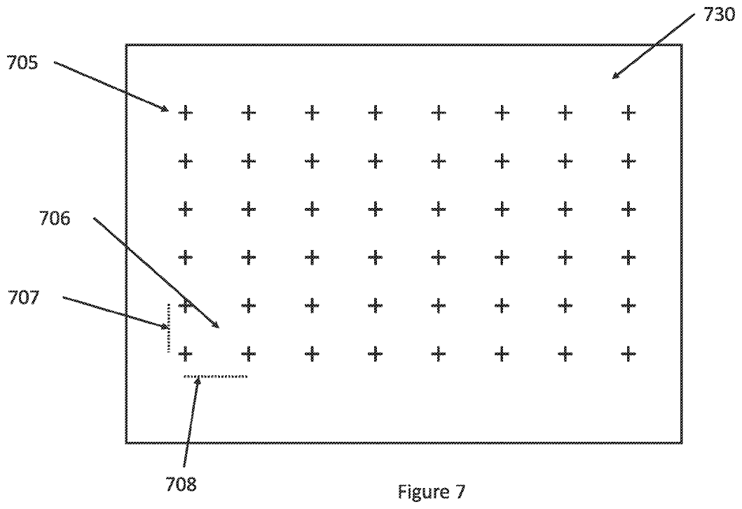

FIG. 7, shows a multilayer textile composite from a top view of the first meltable layer 730 and a regular repeating pattern of tack stitches 705, forming a series of rectangular land areas 706, with the distance between each tack stitch having a land height 707 and a land width 708. The land area 706, in this example, is the land height 707 multiplied by the land width 708.

### EXAMPLES

### Melting and Thermal Stability Test

The test was used to determine the thermal stability of textile materials. This test was based on thermal stability test as described in section 8.3 of NFPA 1975, 2004 Edition. The test oven was a hot air circulating oven as specified in ISO 17493. The test was conducted according to ASTM D 751, Standard Test Methods for Coated Fabrics, using the Procedures for Blocking Resistance at Elevated Temperatures (Sections 89 to 93), with the following modifications:

Borosilicate glass plates measuring 100 mm×100 mm×3 mm were used.

A test oven set to a temperature of 300° C., plus or minus 5 degrees centigrade was used. The specimens were allowed to cool a minimum of 1 hour after removal of the glass plates from the oven.

Any sample side sticking to glass plate, sticking to itself when unfolded, or showing evidence of melting or dripping was considered as meltable. Any sample side lacking evidence of meltable side was considered as thermally stable.

### TMA Expansion Test

TMA (Thermo-mechanical analysis) was used to measure the expansion of expandable graphite particles. Expansion was tested with TA Instruments TMA 2940 instrument. A ceramic (alumina) TGA pan, measuring roughly 8 mm in diameter and 12 mm in height was used for holding the sample. Using the macro-expansion probe, with a diameter of roughly 6 mm, the bottom of the pan was set to zero. Flakes of expandable graphite about 0.1-0.3 mm deep, as measured by the TMA probe, were put in the pan. The furnace was closed and initial sample height was measured. The furnace was heated from about 25° C. to 600° C. at a ramp rate of 10° C./min. The TMA probe displacement was plotted against temperature; the displacement was used as a measure of expansion. Furnace Expansion Test

A nickel crucible was heated in a hot furnace at 300° C. for 2 minutes. A measured sample (about 0.5 g) of expandable graphite was added to the crucible and placed in the hot furnace at 300° C. for 3 minutes. After the heating period, the crucible was removed from the furnace and allowed to cool and then the expanded graphite was transferred to a measuring cylinder to measure expanded volume. The expanded volume was divided by the initial weight of the sample to get expansion in cc/g units.

### DSC Endotherm Test

Tests were run on a Q2000 DSC from TA Instruments using TZERO T™ hermetic pans. For each sample, about 3 milligrams (mg) of expandable graphite were placed in the pan. The pan was vented by pressing the corner of a razor blade into the center, creating a vent that was approximately 2 mm long and less than 1 mm wide. The DSC was equilibrated at 20° C. Samples were then heated from 20° C. to 400° C. at 10° C./min. Endotherm values were obtained from the DSC curves.

### Flexibility or Hand Measurement Test

Hand measurements of laminate structure samples were obtained using a Thwing-Albert Handle-o-meter (model #211-5 from Thwing Albert Instrument Company, Philadelphia, PA). Lower values indicate lower load required to bend the samples and indicates more flexible sample.

### Thickness Test

Thickness was measured by placing the membrane or textile laminate between the two plates of a Mitutoyo 543-252BS Snap Gauge. The average of the three measurements was used.

### Thickness Change Test

Samples were tested for initial thickness as per ASTM D751, section 9 with the exception that the pressure foot diameter is 2.54 centimeter. The instrument is adjusted to apply a pressure force of approximately 0.239 kg/cm² (3.4 psi) to the specimen. After exposure to Horizontal Flame Test for 60 seconds (or after break-open if break-open occurred prior to 60 seconds), the sample is re-measured for thickness change. Thickness and integrity of the expanded structure are observed after testing.

### Composite Weight

The weights of each example were determined by ASTM D3776/3776M-20 (R2020) Option C.

### Barrier Thermal Stability Test

Preferably, a thermally stable barrier layer has an air permeability after thermal exposure of less than 25 l/m2/sec. To determine the thermal stability of a thermally stable barrier layer, a 381 mm (15 in.) square fabric specimen was clamped in a metal frame and then suspended in a forced air-circulating oven at 260° C. (500° F.). Following a 5-minute exposure, the specimen was removed from the oven. After allowing the specimen to cool down, the air permeability of the specimen was tested according to ISO 9237 (1995). Specimens with less than 25 l/m2/sec were considered as a thermally stable barrier layer.

Air permeability test was performed according to ISO 9237 (1995).

Arc Thermal Performance Value was tested according to ASTM F1959 (a flat panel test which is equivalent to EIC 61482-1-1).

Composite thickness tests were performed according to ASTM D1777.

### Preparation of Heat Reactive Material #1

Heat Reactive Material #1 was produced according to the following procedure. A flame retardant polyurethane resin was prepared by first forming a resin according to commonly owned U.S. Pat. No. 4,532,316 and adding into the reactor a phosphorus-based flame retardant material, in an amount of about 45% by weight. After the polyurethane resin was formed, 76 grams of the polyurethane resin was mixed with 24 grams of expandable graphite (the expandable graphite having an expansion of greater than 900 micrometers at 280° C. as determined by the TMA expansion test) at 80° C. in a stirring vessel. The mixture was cooled and used as is.

### Laminate #1

Laminate #1 is a two-layer laminate, available from W.L. Gore and Associates, Elkton, MD as SAAL07900OF, and is a meltable polyester woven textile that is adhered to a GORE-TEX ePTFE membrane using a heat reactive material comprising a polyurethane resin that contains expandable graphite particles in a repeating discontinuous dot pattern. The laminate weight was about 228 gsm.

### Laminate #2

Laminate #2 is a commercially available 3-layer laminate, available from W.L. Gore and Associates, Elkton, MD as CORT000600B. The laminate comprises a meltable outer layer bonded to an ePTFE membrane using a polyurethane resin that contains expandable graphite particles in a repeating discontinuous dot pattern. The innermost flame retardant (FR) textile, containing FR viscose, aramid and anti-static fibers, is bonded to the ePTFE layer using a flame retardant polyurethane adhesive with a discontinuous dot pattern of the adhesive. The 3-layer laminate has a weight of about 322 gsm.

### Laminate #3

Laminate #3 is a 2-layer laminate. The laminate was produced by laminating a meltable 71 gsm plain weave polyester textile (available from Milliken & Co., Spartanburg, SC) to a GORE-TEX® ePTFE membrane (part #10898200, available from W.L. Gore and Assoc., Elkton, MD) using a polyurethane resin that contains expandable graphite particles in a repeating discontinuous dot pattern. The 2-layer laminate has a weight of about 168 gsm (5.93 oz/yd²).

### Laminate #4

Laminate #4 is 2-layer laminate. The laminate was produced by laminating a meltable polyester knit textile (part #A04Y014AZ, available from Nan Ya Plastics, Kaohsiung City, Taiwan) to a GORE-TEX® ePTFE membrane (part #10898200, available from W.L. Gore and Associates, Elkton, Maryland) using a heat reactive material comprising a polyurethane resin that contains expandable graphite particles in a repeating discontinuous dot pattern. The 2-layer laminate has a weight of about 180 gsm (6.35 oz/yd²).

### Laminate #5

Laminate #5 is a 3-layer laminate. The laminate is available from W.L. Gore and Associates, Elkton, MD as part #FERM002001 and is a meltable nylon knit textile that is adhered to a GORE-TEX ePTFE membrane using a heat reactive material comprising a polyurethane resin that contains expandable graphite particles in a repeating discontinuous dot pattern. Bonded to the ePTFE membrane is an FR backer that contains 48% aramid, 50% FRviscose, and 2% carbon fiber, and is available from Schüler & Co., Göppingen, Germany.

### Preparation of Multilayer Composite Textile #1

2 layers of laminate #1 were stitched together as the first portion and the second portion, using an aramid thread available from Mid-West Quilting Co. LTD., Winnipeg, Manitoba. The ePTFE layer of the first portion was placed in contact with the meltable layer of the second portion. The stitching was a continuous quilting stitch in a 10.2 cm×10.2 cm diamond shape providing a land area of about 104 cm². The multilayer textile composite had a weight of about 460 gsm (13.56 oz/yd²).

### Preparation of Multilayer Composite Textile #2

A layer of laminate #1 was quilted to laminate #2 with the ePTFE layer of laminate #1 contacting the meltable layer of laminate #2. The quilting used an aramid thread available from Mid-West Quilting Co. LTD., Winnipeg, Manitoba. The stitching was a continuous quilting stitch in a 10.2 cm×10.2 cm diamond shape providing a land area of about 104 cm². The multilayer textile composite had a weight of about 550 gsm (16.22 oz/yd²).

### Preparation of Multilayer Textile Composite #3

A layer of 2-layer laminate #3 was quilted to the 3-layer laminate #2, with the ePTFE layer of laminate #3 contacting the meltable layer of laminate #2. The quilting used an aramid thread available from Mid-West Quilting Co. LTD., Winnipeg, Manitoba. The stitching was a continuous quilting stitch in a 10.2 cm×10.2 cm diamond shape providing a land area of about 104 cm². The multilayer textile composite had a weight of about 523 gsm (15.43 oz/yd²).

### Preparation of Multilayer Textile Composite #4

A layer of 2-layer laminate #3 was quilted to a layer of a plain weave 50% aramid/50% viscose flame retardant textile, part #KRVC001A, available from Schüler & Co. Göppingen, Germany. The ePTFE layer of laminate #3 (first portion) was placed in contact with the plain weave textile (second portion). The quilting used an aramid thread available from Mid-West Quilting Co. LTD., Winnipeg, Manitoba. The stitching was a continuous quilting stitch in a 10.2 cm×10.2 cm diamond shape providing a land area of about 104 cm². The multilayer textile composite had a weight of about 344 gsm (10.16 oz/yd²).

### Preparation of Multilayer Textile Composite #5

A layer of the 3-layer laminate #2 (first portion) was quilted to another layer of the 3-layer laminate #2 (second portion). The FR textile of the first portion was placed in contact with the meltable layer of the second portion. The quilting used an aramid thread available from Mid-West Quilting Co. LTD., Winnipeg, Manitoba. The stitching was a continuous quilting stitch in a 10.2 cm×10.2 cm diamond shape providing a land area of about 104 cm². The multilayer textile composite had a weight of about 640 gsm (18.9 oz/yd²).

### Preparation of Multilayer Textile Composite #6

A layer of laminate #4 as the first portion was quilted with a layer of FR200 THINSULATE® insulation, available from 3M, St. Paul, Minnesota as the third portion and a layer of 120 gsm 50% aramid/50% viscose plain weave textile part #KRVC001A, available from Schüler & Co., Göppingen, Germany as the second portion. The ePTFE layer of the first portion was placed in contact with one side of the third portion and the second portion was placed in contact with the other side of the third portion. The quilting used an aramid thread available from Mid-West Quilting Co. LTD., Winnipeg, Manitoba. The stitching was a continuous quilting stitch in a 10.2 cm×10.2 cm diamond shape providing a land area of about 104 cm². The multilayer textile composite had a weight of 559 gsm.

### Preparation of Multilayer Textile Composite #7

A layer of laminate #4 as the first portion was quilted with a layer of FR120 THINSULATE® insulation, available from 3M, St. Paul, Minnesota as the third portion and a layer of laminate #4 as the second portion. The ePTFE layer of the first portion was placed in contact with one side of the third portion and the second portion was placed in contact with the meltable textile of the third portion. The quilting used an aramid thread available from Mid-West Quilting Co. LTD., Winnipeg, Manitoba. The stitching was a continuous quilting stitch in a 10.2 cm×10.2 cm diamond shape providing a land area of about 104 cm². The multilayer textile composite had a weight of 549 gsm.

### Preparation of Multilayer Textile Composite #8

Laminate #1 as the first portion was quilted together with laminate #5 as the second portion. The ePTFE membrane of the first portion was placed in contact with the nylon textile of second portion. The quilting used an aramid thread available from Mid-West Quilting Co. LTD., Winnipeg. Manitoba. The stitching was a continuous quilting stitch in a 10.2 cm×10.2 cm diamond shape providing a land area of about 104 cm². The multilayer textile composite had a weight of 542 gsm (estimated).

### Preparation of Multilayer Textile Composite #9

Laminate #1 as the first portion was quilted together with laminate #5 as the second portion. The ePTFE membrane of the first portion was placed in contact with the nylon textile of second portion. The quilting used an aramid thread available from Mid-West Quilting Co. LTD., Winnipeg. Manitoba. The stitching was a continuous quilting stitch in a 5.1 cm×5.1 cm diamond shape providing a land area of about 26 cm². The multilayer textile composite had a weight of 550 gsm (estimated).

### Preparation of Comparative Textile Composite A

A layer of 2-layer laminate #2 was attached to a layer of a layer of 120 gsm 50% aramid/50% viscose plain weave textile part #KRVC001A, available from Schüler & Co. Göppingen, Germany. The two layers were joined to each other by stitching around the perimeter of the sample, simulating a hung liner in a garment. The composite had a weight of about 374.0 gsm.

### Preparation of Comparative Textile Composite B

Two layers of 271 gsm TWARON® aramid textile were quilted together with a layer of a 3-ply Basofil/aramid blend spunlace quilted to a NOMEX® aramid face. The quilting of the 3 layers was performed using an aramid thread available from Mid-West Quilting Co. LTD., Winnipeg, Manitoba. The stitching was a continuous quilting stitch in a 10.2 cm×10.2 cm diamond shape providing a land area of about 104 cm². The multilayer textile composite had a weight of about 807 gsm.

### Comparative Textile Composite C

Comparative C was OMNI QUILT™ thermal liner available from Norfab, Norristown, PA. This material has a weight of about 366 gsm (estimated).

Table 1 shows the thickness, weight, and Arc Thermal Protection Value of the examples. All values are measured according to the procedures given, unless otherwise noted.

TABLE 1

| | Thickness | | ATPV |
|---|---|---|---|
| Textile | (millimeters, | Weight | (calories/cm², |
| Composite # | ASTM D1777) | (grams/m²) | ASTM F1959) |
| 1 | 1.5 | 460 | 92 |
| 2 | 1.95 | 550 | 105 |
| 3 | 1.75 | 523 | 90-100 (est.) |
| 4 | 1.65 to 1.85 | 344 | 45-47 (est.) |
| 5 | 2.18 | 640 | 100 (est.) |
| 6 | 2.5 (est.) | 559 | 75 (est.) |
| 7 | 2.25 (est.) | 549 | 75 (est.) |
| 8 | n/a | 542 (est.) | 101 |
| A | 2 | 374 | 47 |
| B | 4 | 807 | 100 |
| C | 2.75 to 2.95 | 366 (est.) | 41 |
| | (est.) | | |

Examples 1-4 show that multilayer textile composites of the present disclosure can provide relatively thin, lightweight structures and protection against arc flash injury. For example, comparative example A is an approximately 2 millimeter thick composite and provides only 47 cal/cm² arc protection. In contrast, examples 1 and 2 are less than 2 millimeter thick and can provide 92 to 105 cal/cm² protection, much higher than the performance of comparative example A.

1. A multilayer textile composite comprising:
A) a first portion; and
B) a second portion,
wherein the first portion comprises a) a first laminate comprising;
a1) a first meltable layer;
a2) a first layer of a heat reactive material comprising a polymer resin and expandable graphite; and
a3) a first barrier layer;
wherein the first portion and the second portion are attached to each other via one or more stitches.

2. The multilayer textile composite of claim 1,
wherein the first laminate further comprises a4) a first flame retardant textile, and
wherein the first flame retardant textile is adjacent to the first barrier layer opposite the first layer of heat reactive material.

3. The multilayer textile composite of claim 1, wherein the second portion comprises
b) a second laminate, the second laminate comprising;
b1) a second meltable layer;
b2) a second layer of the heat reactive material comprising a polymer resin and expandable graphite; and
b3) a second barrier layer.

4. The multilayer textile composite of claim 3, wherein the second laminate further comprises b4) a second flame retardant textile, and
wherein the second flame retardant textile is adjacent to the second barrier layer opposite the second layer of heat reactive material.

5. The multilayer textile of claim 1, wherein the second portion comprises a third flame retardant textile.

6. The multilayer textile composite of claim 1, wherein second portion is adjacent to the first barrier layer of the first portion.

7. The multilayer textile composite of claim 2, wherein the second portion is adjacent to the first flame retardant textile of the first portion.

8. The multilayer textile composite of claim 1, wherein the second portion comprises the second laminate, and the second meltable layer is adjacent to the first barrier layer of the first portion.

9. The multilayer textile composite of claim 2, wherein the second portion comprises the second laminate, and wherein the second meltable layer is adjacent to the first flame retardant textile of the first portion.

10. (canceled)

11. The multilayer textile composite of claim 1, wherein the one or more stitches are quilting stitches, a series of one or more stitch lines, a series of overlapping stitch lines, a series of stitched geometric shapes, a series of stitches in a grid pattern, a series of stitches that are essentially parallel to each other, a series of tack stitches, or a combination thereof.

12. The multilayer composite of claim 1, wherein the one or more stitches are quilted stitches in a stitch pattern comprising one or more land areas, wherein each land area is bordered by the quilted stitches, and wherein the land areas of the quilted pattern are in a range of from 1 centimeter² (cm²) to 450 cm².

13. (canceled)

14. (canceled)

15. (canceled)

16. The multilayer textile composite of claim 1, wherein the first layer of heat reactive material and the second layer of heat reactive material are independently applied in a continuous or a discontinuous manner.

17. The multilayer textile composite of claim 1, wherein the multilayer textile composite has a weight in a range of from 300 to 800 grams per square meter (gsm).

18. The multilayer textile composite of claim 1, wherein the first and/or the second barrier layer each independently comprises expanded polytetrafluoroethylene, polytetrafluoroethylene, polyurethane, polyethylene (PE) or a combination thereof.

19. (canceled)

20. The multilayer textile composite of claim 1, wherein the stitches connect at least a portion of a thickness of the first portion with at least a portion of a thickness of the second portion.

21. The multilayer textile composite of claim 1, wherein the stitches connect an entire thickness of the first portion with an entire thickness of the second portion.

22. The multilayer textile composite of claim 21, wherein the stitches are present on at least one surface of the multilayer textile composite or wherein the stitches are present on both surfaces of the multilayer textile composite.

23. An article comprising the multilayer textile composite of claim 1.

24. (canceled)

25. The article of claim 23, wherein the article is a garment, and the first portion of the multilayer textile composite is positioned on an exterior side of the garment.

26. The article of claim 23, wherein the article provides an Arc Thermal Performance Value of at least 40 calories/centimeter² (cal/cm²), when tested according to ASTM F1959.
